(19) United States
(12) Patent Application Publication
(10) Pub. No.: US 2009/0222663 A1
(43) Pub. Date: Sep. 3, 2009

(54) System and Method for Authenticating the Identity of a Remote Fax Machine

(76) Inventors: Stanley Chow, Ottawa (CA); Christophe Gustave, Ottawa (CA); Brad McFarlane, Ottawa (CA); Bassem Abdel-Aziz, Kanata (CA)

Correspondence Address: FAY SHARPE/LUCENT, 1228 Euclid Avenue, 5th Floor, The Halle Building, Cleveland, OH, 44115-1843, US

(21) Appl. No.: 12/039,946

(22) Filed: Feb. 29, 2008

(51) Int. Cl. H04L 9/00

(52) U.S. Cl. 713/170

(57) ABSTRACT

A system and method of authenticating the identity of a remote fax machine during a faxing operation is provided. An X.509-type Certificate received from the remote fax machine is validated to affirm it can be properly associated with the remote machine. The Certificate's public key is used to verify the remote fax machine has the corresponding private key. A Certificate's Common Name then compared to an Expected Name to authenticate the identity of the remote fax machine prior to sending a fax to prevent an unwanted misdirection of faxed information and to screen incoming faxes for unwanted spam.

### BACKGROUND OF THE INVENTION

This invention relates to the art of transmitting facsimiles, referred to herein as faxes, between fax machines, and more particularly to systems and methods of confirming the identities of remote fax machines across a network as part of a faxing operation.

Faxes continue to be a useful and convenient means of sending information from one fax machine to another across vast distances. A fax machine can be a stand alone machine dedicated to sending and receiving only faxes, or it can be part of a multifunction machine capable of performing a plurality of different types of operations in a office environment.

The faxing operation can be performed manually by an operator operating the fax machine, or it can be partially or mostly automated to send documents electronically. These documents can often include confidential information which is not intended to be disclosed to parties other than the intended party owning/operating the receiving fax machine.

During a faxing operation in which a fax is to be sent from a sending machine, also referred to as a calling machine, to a receiving machine, also referred to as a called machine, the calling machine dials the fax number of the called machine to establish a modem connection between the machines and the fax is transmitted to the receiving machine.

If the sending machine reaches a fax machine, as determined during the establishment of the modem connection, the fax will be sent unless precautions are made to verify the identity of the receiving machine. Simple typographical errors made in the called fax number can result in unwanted misdirection of sensitive information resulting in the need for destination verification.

There are products that check the fax numbers called by the calling fax machine, however these are not sufficiently effective for an enterprise with many frequently changing fax numbers. The use of CallerID has been proposed to verify the validity of the called fax number, however, with VoIP/SIP here are many easy ways to forge CallerID, decreasing the security of this solution.

Products that authenticate with hardware or passwords operating as “lock and key” can secure a known (and fixed) group of fax machines but they do not enable a simple way of reaching fax machines outside the secure group. Such products have a high administrative overhead. If a user/fax machine has to fax to multiple machines at different fax numbers in different companies, the faxing operation can be difficult since these products require passwords to be shared between machines. For high volume locations that have multiple fax numbers with a single number, the problem multiplies.

The present disclosure contemplates new and improved systems and methods that resolve the above-referenced difficulties and others.

### SUMMARY OF THE INVENTION

A method and apparatus for of authenticating identities of remote fax machines across a network using X.509-type Certificate validation with Common Name verification is provided.

In one aspect of the invention a method includes receiving a X.509-type Certificate having a Certificate public key and a Common Name from a remote fax machine, receiving an encrypted nonce from the remote fax machine, validating the X.509-type Certificate, decrypting the nonce, comparing the Common Name with an Expected Name, and determining the authenticity of the identity of the remote fax machine.

In another aspect of the system includes a fax machine controller for establishing a modem connection with a remote fax machine, receiving a X.509-type Certificate having a Certificate public key and a Common Name from the remote fax machine via the modem connection, receiving an encrypted nonce from the remote fax machine via the modem connection, validating the X.509-type Certificate, decrypting the nonce with the Certificate public key, comparing the Common Name with an Expected Name, and determining the authenticity of the identity of the remote fax machine.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating system components of the exemplary embodiments as described herein;

FIG. 2 is a flow chart illustrating a method of authenticating the identity of a remote fax machine; and

FIGS. 3-5 include a flow chart illustrating another embodiment of a method of authenticating the identity of a remote fax machine.

### DETAILED DESCRIPTION

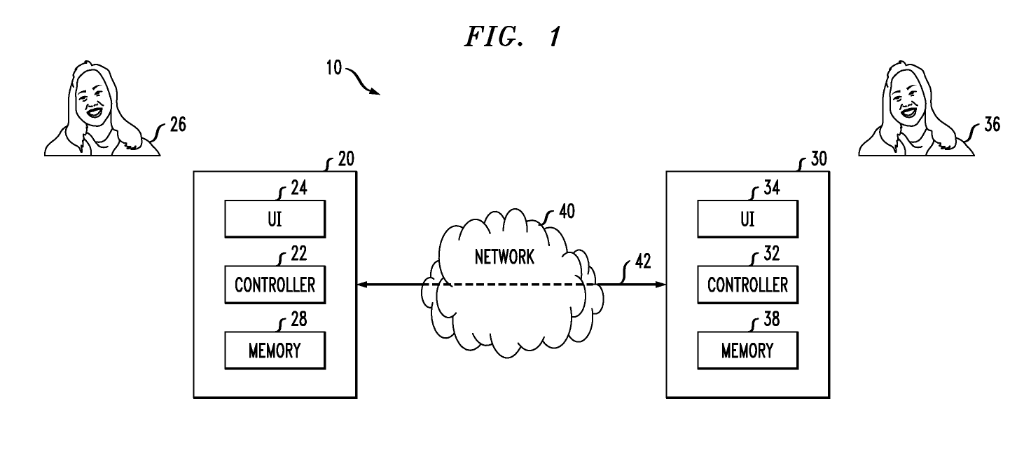

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally at 10, FIG. 1 includes a calling fax machine, referred to herein as CGFM 20, which places a call to a called fax machine, referred to herein as CDFM 30 across a telecommunications network 40 for the purpose of establishing a modem connection 42 between the machines and sending a fax to the CDFM 30. The network 40 can be a Public Switched Telephone Network (PSTN) or other telecommunications network capable of supporting a modem type connection between the machines 20, 30 for sending faxes therebetween.

The CGFM 20 includes a controller 22 for controlling the operation of the fax machine, including setting up a modem connection with the CDFM 30, communicating with the CDFM 30 for negotiating various parameters needed for sending the fax, and running programmed instructions for performing the authentication operations for authenticating the identity of the CDFM 30 across the network 40, as described below. The CGFM 20 also includes a user interface (UI) 24, which can be controlled by controller 22, or by a separate controller if so desired, for enabling the fax operator 26 to enter commands and other information for operating the fax machine. It is contemplated that operator 26 may not be needed and the faxing operation and authentication feature(s) described herein may be automated where applicable. The CGFM 20 also includes memory 28 for storing an expected Common Name for the CDFM 30, as shall be described in further detail below.

The CDFM 30 can a controller 32 for controlling the operation of the fax machine, including setting up a modem connection with the CGFM 20, communicating with the CGFM for negotiating various parameters needed for sending the fax, and running programmed instructions for performing the authentication operations for authenticating the identity of the CGFM across the network 40, as described below. The CDFM 30 can also include a user interface (UI) 34, which can be controlled by controller 32, or by a separate controller if so desired, for enabling the fax operator 36 to enter commands and other information for operating the fax machine. It is contemplated that operator 36 may not be needed and the faxing operation and authentication feature(s) described herein may be automated where applicable. The CDFM 30 also includes memory 38 for storing an expected Common Name for the CGFM 30, as shall be described in further detail below.

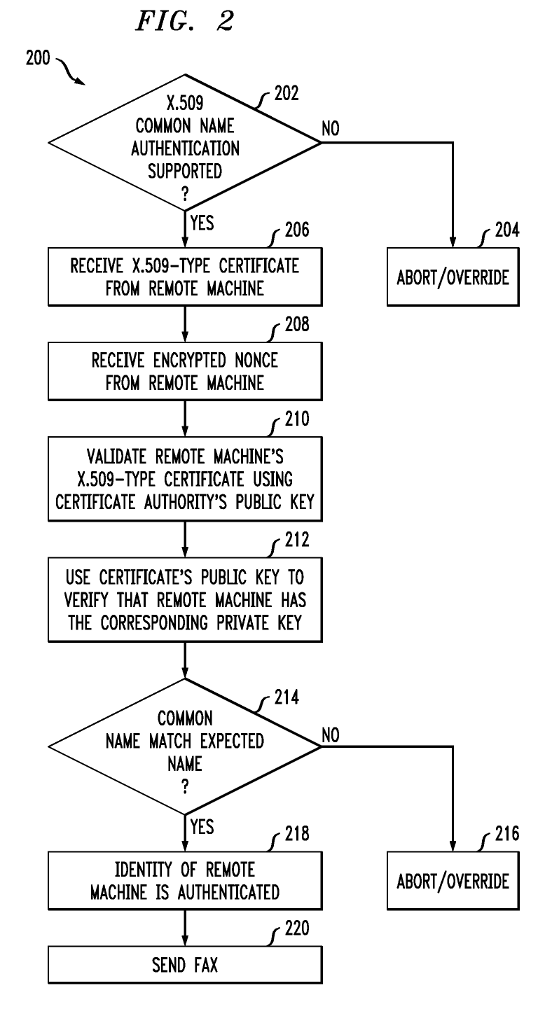

Referring now to FIG. 2, a method of authenticating identities of remote fax machines across a network using X.509-type Certificate validation with Common Name verification is shown generally at 200. The method 200 includes determining that the remote fax machine (that is, the fax machine disposed at a different location and connected via a modem connection formed across the network 40) supports the identity authentication feature described herein at 202. Support for this feature can be determined using ITU V.xx-type signaling commonly passed between machines as part of the process of establishing the modem connection during which other parameters needed for establishing a successful modem connection are negotiated, such as speed, compression, etc.

As described in further detail below, the identity authentication feature can be used in a unidirectional manner, such as a CGFM authenticating the identity of a CDFM, or in a bi-directional manner such that both machines authenticate each other's identity. Identities can be authenticated before the fax is sent to prevent unwanted misdirection of faxes. The first general example described with reference to FIG. 2 shall be a unidirectional example in which the CGFM 20 authenticates the identity of the remote CDFM 30 before sending the fax. If it is determined at 202 that the CDFM 30 does not support the use of the identity authentication feature, the fax operation may be aborted or overridden at 204, as shall be described in further detail below.

If it is determined that the CDFM 30 does support the use the identity authentication feature at 202, the CDFM sends a X.509-type Certificate to the CGFM 20 which receives it at 206. The X.509-type Certificate can be sent in digital form via the modem connection.

The X.509-type Certificate includes a public key, which can be referred to as the Certificate public key, and a Common Name for the CDFM 30. The Common Name can be the name of the company, or other enterprise, authorized to receive faxes sent to the fax machine. The Common Name can include a plurality of group level identifiers which can be used to categorize the machine, ranging from high group level identifiers identifying large groups such as the name of the company to low level identifiers used to refer to subgroups such as office locations, departments, floors, or particular machines, etc. For example, a Common Name can be “XYZ Bank, accounts payable, department B” includes three level identifiers. Wildcard characters, such as for example “*”, “$”, or other characters, can be used for level identifiers to refer to all machines at that level. Alternatively, if lower levels exist but are not included in the common name, all machines at the lower identity levels not included in the Common Name may be identified in this manner.

The CDFM 20 can also send an encoded nonce to the CGFM 30 which receives it at 208. The CDFM 30 encodes a nonce using the CDFM's private key, which is associated with the CDFM's X.509-type Certificate, to form the encoded nonce. The X.509-type Certificate and the encoded nonce can be transmitted in a single transmission or several transmissions over the modem connection.

The CGFM 20 validates the CDFM X.509-type Certificate using the certificate authority's (CA) public key, in a conventional manner at 210, verifying that the CDFM X.509-type Certificate public key is from, or can properly be associated with, the CDFM 30.

The CGFM 20 then verifies, at 212, that the CDFM 30 actually does have the private key corresponding to the X.509-type Certificate by decrypting the encoded nonce, received at 208, using the public key from the CDFM X.509-type Certificate. The result of this decryption can be compared to the original nonce, which can be sent to CDFM at 208, or in other manners. If the decrypted nonce matches the original nonce, the CGFM 20 completes this verification. An alternate variation can include the CGFM 20 encrypting a nonce (using the certificate public key), sending the encrypted nonce to the CDFM 30 which decrypts it (using the private key) and returns the plain text nonce to the CGFM for comparison with the original nonce. Other more complex protocols can be used, if so desired. Determining that the CDFM 30 has the private key at 212, enables the CGFM 20 to confirm the authenticity of the Common Name in the CDFM X.509-type Certificate as belonging to the CDFM 30.

The CGFM 20 then compares the Common Name in the CDFM X.509-type Certificate with an expected name for the CDFM 30 at 214. The expected name can be provided or retrieved in various manners as described in further detail below. If the common name does not match the expected name at 214, the fax operation can be abandoned or the authentication process can be overridden at 216 as described in further detail below.

If the names match at 214, the identity of the CDFM 30 is authenticated at 218 and the CGFM 20 sends the fax to the CDFM 30 at 220. The CGFM 20 authenticates the identity of the remote CDFM 30 in this manner prior to sending the fax so as to avoid sending the fax to the wrong machine.

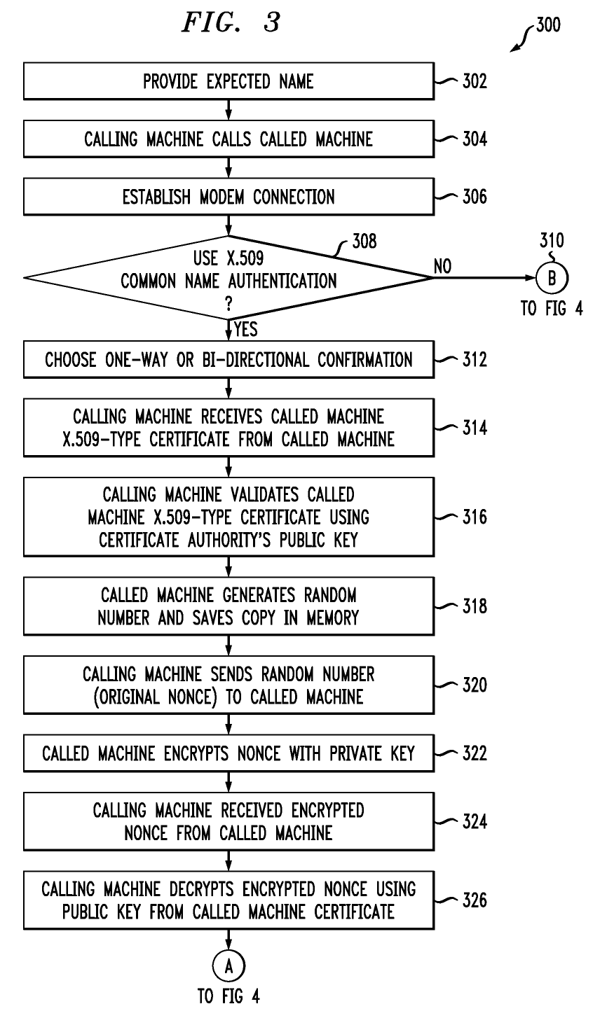

Referring now to FIG. 3-5 a more detailed example of a method of authenticating identities of remote fax machines across a network using X.509-type Certificate validation with Common Name verification shall now be described.

The expected name for the CDFM 30 is provided at 302 and saved in memory 28. The expected name can be provided by the 26 of the CGFM 20 at part of the faxing operation, such as by using the User Interface 24. The expected name can also be provided in an earlier operation, prior to faxing, and saved in memory 28. A plurality of expected names can be provided and saved for the remote machines which the CGFM 20 can be expected to send faxes to, if so desired. Expected names can be provided as individually or in a bulk operation and new ones can be added at any time. In these examples, the operator 26 can then select the desired expected name from a menu in the User Interface 24, or in other manners, as part of the faxing operation. It is further contemplated that the expected name can be provided in other manners, at 302, if so desired.

The expected name for CGFM 20 can also provided at 302 to enable the CDFM 30 to authenticate the identity of the CGFM, such as in bidirectional authentication, if so desired. The CGFM expected name is provided and saved in the memory 38 of the CDFM 30 in manners similar to the CDFM expected names described above.

The faxing operation is then initiated such that the CGFM 20 calls the CDFM 30 at 304 for the purposes of attempting to send a fax from the CGFM 20 to the CDFM.

A modem connection between the CGFM 20 and the CDFM 30 is established across the Network 40 at 306. Various negotiations between the machines 20 and 30 can occur over the modem connection, such as for example setting up a modem speed that can be accommodated by both machines.

It is then determined if the CDFM 30 supports the use of X.509-type Certificate identity authentication for remote fax machines using Common Name verification for confirming the identity of the machine at 308, in a manner as described at 202 above. If the CDFM 30 does not support this feature, the fax operation may continue at 310, such as by enabling the authentication feature to be overridden as described below.

If the CGFM 20 determines that the CDFM 30 supports this feature at 308, uni-directional or bidirectional identity authentication for the faxing operation is chosen at 312, such as using similar protocols for negotiating other modem parameters. In this example, bidirectional identity confirmation is chosen in which CGFM 20 uses an X.509-type Certificate from the CDFM 30 to confirm the identity of the machine receiving the fax, and CDFM 30 uses an X.509-type Certificate from the CGFM 20 to confirm the identity of the machine sending the fax. Bi-directional authentication, like unidirectional, occurs before the fax is actually sent.

The CDFM 30 sends a CDFM X.509-type Certificate to the CGFM 20 which receives it at 314. As stated above, the Certificate includes a public key and a Common Name.

The CGFM 20 validates the CDFM X.509-type Certificate using the public key from the Certificate Authority that issued the Certificate at 316, in a similar manner as described at 210 above. Validation of the Certificate verifies that the public key associated with the certificate is from, or can properly be associated with, the CDFM 30.

The CGFM 20 generates a random number, for use as a nonce, at 318 and retains a copy of it in memory 28 for later use, as described below. The CGFM 20 then sends the random number nonce to the CDFM 30 at 320. The CDFM 30 encrypts the nonce with its private key associated with the CDFM X.509-type Certificate at 322. The CDFM 30 sends the encrypted nonce to the CGFM 20 which receives it at 324.

The CGFM 20 decrypts the encrypted nonce using the public key included in the CDFM X.509-type Certificate at 326.

The CGFM 20 compares the decrypted nonce with the nonce it saved at 318 above at 330. If the decrypted nonce matches the original nonce at 330, the CDFM 30 is confirmed to posses the private key associated with the CDFM X.509-type Certificate at 332. Next, the CGFM 20 compares the Common Name contained in the certificate with the expected name for the CDFM 30 provided at 302 above. If the common name matches the expected name at 334, the identity of the CDFM is authenticated at 336 and unidirectional authentication has been completed.

It is then determined if bidirectional authentication is being performed at 338. If only unidirectional identity authentication is being performed, the CGFM 20 sends the fax to the CDFM 30 at 342.

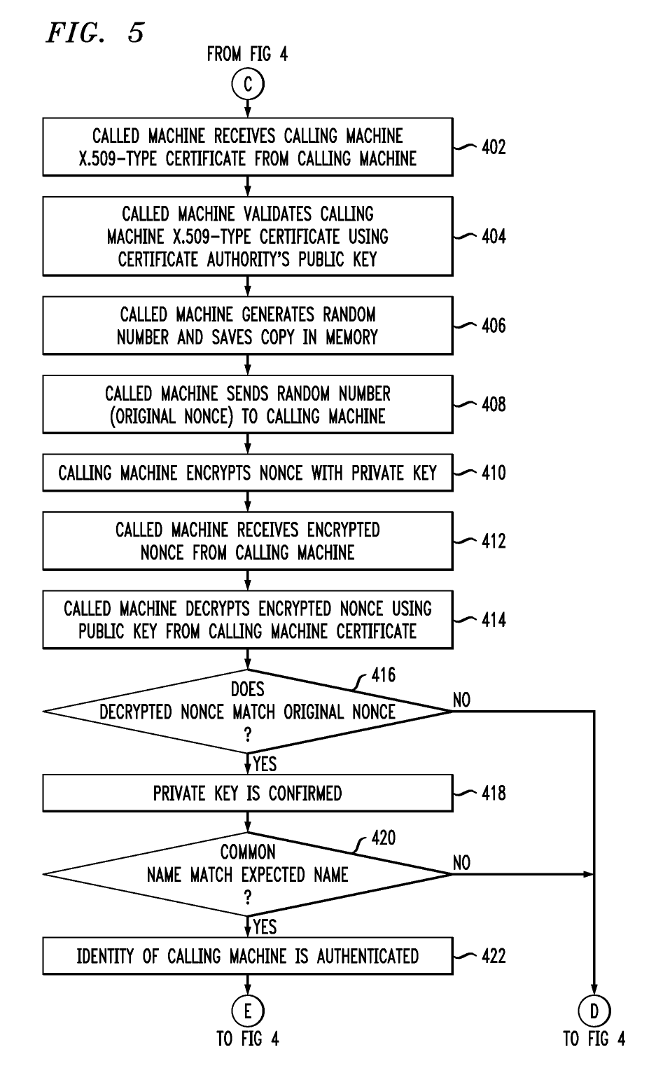

In this bi-directional example, authentication of the identity of the CGFM 20 is authenticated by the CDFM 30 at 400 as shown in FIG. 5. The CDFM 30 receives the CGFM X.509-type Certificate from the CGFM 20 at 402 containing a public key and a Common Name associated with the CGFM. The Common Name can also include level identifiers and wildcard characters as described above if so desired.

The CDFM 30 generates a random number and saves it in memory 38 at 406. The CDFM 30 sends the random number to the CGFM 20 at 408. The CGFM 20 encrypts the nonce with its private key associated with the X.509-type Certificate at 410. The CGFM 20 sends the encrypted nonce to the CDFM 30 which receives it at 412. The CDFM 30 decrypts the encrypted nonce using the public key from the CGFM 20 Certificate at 414. The CDFM 30 compares the decrypted nonce with the nonce it generated and saved at 406 to determine if they match at 416. If they do not match, the identity of the CGFM 20 cannot be authenticated, however the faxing operation can be continued by overriding the authentication feature as described below.

If the decrypted nonce matches the original nonce at 416, the CDFM 30 confirms that the CGFM 20 has the private key associated with the CGFM X.509-type Certificate at 418. The CDFM 30 the compares the Common Name in the CGFM X.509-type certificate with the CGFM expected name, provided at 302 above, and if they match at 420 the identity of the CGFM 20 is authenticated at 422. This completes the bi-directional authentication and the CGFM 20 sends the fax to the CDFM 30 at 342.

Authentication of the CGFM 20 in this manner can also be performed in a unidirectional manner by switching the CGFM and CDFM 30 in steps 302-336 above to enable the CDFM to authenticate the identity of the CGFM and abort a faxing operation if the sending machine is not among a list of machines approved for sending faxes to the CDFM 30. This would screen incoming faxes by identifying fax Spammers and prevent them from sending unwanted faxes to a called machine.

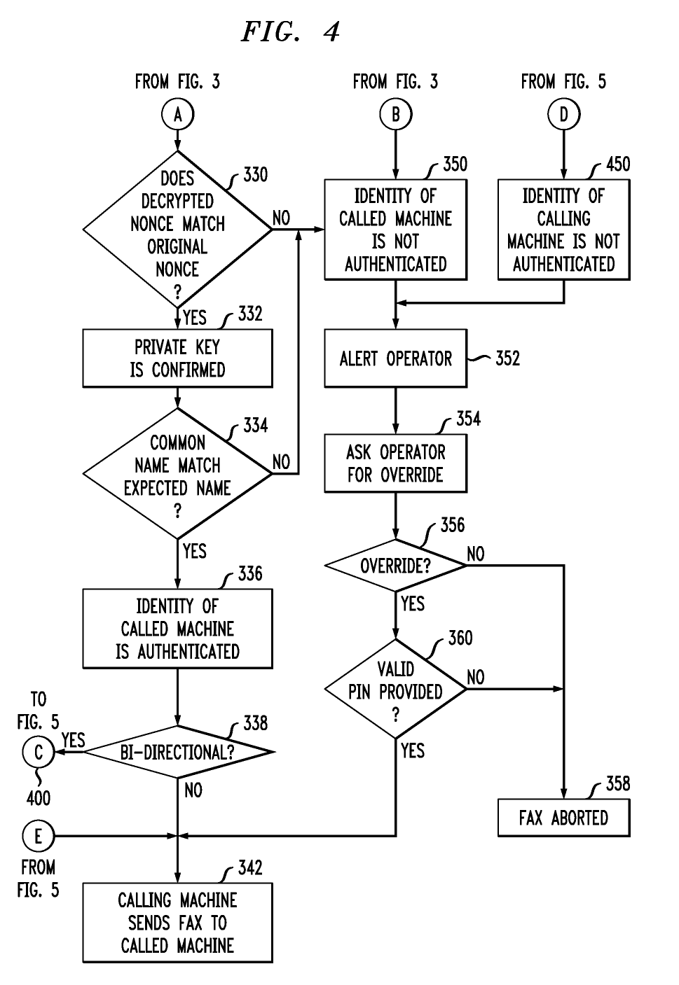

Optional provisions can be made to allow the operator 26 to override the authentication feature in a variety of situations and still send the fax to the CDFM 30 at 342, if so desired. For example, if the remote fax machine, such as the CDFM 30, does not support the remote fax machine identity authentication feature at 308, the identity of the CDFM 30 cannot be authenticated as shown at 350 in FIG. 4. The Operator 26 can be alerted, such as via the User Interface 24, that the identity of the CDFM 30 cannot be authenticated at 352. The Operator 26 can then asked if he or she would like to override and continue faxing at 354. If the Operator indicates he or she would like to override at 356, an optional Personal Identification Number may be requested and if the Operator provides the PIN at 358, the CGFM 20 sends the fax to the CDFM 30 at 342. If the Operator indicates not to override at 356, or if an invalid PIN is entered at 358, the fax operation is aborted at 356 and no fax is sent.

If the nonce decrypted by the CGFM 20 at 326 does not match the original nonce at 330, or if the common name in the CDFM X.509-type Certificate does not match the expected name as determined by the CGFM 20 at 334, the identity of the CDFM 30 cannot be authenticated 350. However, the authentication feature may optionally be overridden by the Operator 26, and the fax sent at 342, as just described,.

Similarly, if the nonce decrypted by the CDFM 30 at 414 does not match the original nonce at 416, or if the common name in the CGFM X.509-type Certificate does not match the expected name as determined by the CDFM 30 at 420 as part of the bidirectional authentication, the identity of the CGFM 20 cannot be authenticated at 450. In these instances, the Operator can be alerted to this as 352 and asked to override, such as in manners just described, so that the fax is sent at 342, if so desired.

An optional log can be generated to provide information regarding the faxing operation including but not limited to if the fax was sent, if authentication of the remote fax machine was successful and if so, the identity such as the Common Name. The log can also store information if the authentication was overridden such as the PIN code used to do so.

Digital signatures can be exchanged between machines to provide proof that the fax was sent and/or received, the time of receipt, and for verifying the contents of the fax sent, if so desired.

It should be appreciated that these provisions for overriding some or all of these authentication results can be optional, and the fax operation can simply be aborted at 360 if authentication is not, or cannot, be made.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of authenticating the identity of a remote fax machine during a faxing operation comprising:
a calling fax machine establishing a modem connection with the remote fax machine;
receiving a X.509-type Certificate from the remote fax machine via the modem connection, the X.509-type Certificate including a Certificate public key and a Common Name;
validating the X.509-type Certificate using a Certificate Authority public key;
verifying that the remote fax machine is in possession of the private key corresponding to the Certificate public key;
receiving an Expected Name associated with the remote fax machine;
comparing the Common Name with the Expected Name; and
the calling fax machine authenticating the identity of the remote fax machine from the validating and the verifying and the comparing.

2. The method defined in claim 1 further comprising:
sending a fax to the remote fax machine after the authenticating.

3. The method defined in claim 1 further comprising;
aborting the faxing operation based on the outcome of the validating or the determining or the authenticating.

4. The method defined in claim 1 further comprising:
determining that the identity of the remote fax machine is not authenticated;
altering a fax machine operator that the identity of the remote fax machine is not authenticated; and
prompting the fax machine operator to override if so desired.

5. The method defined in claim 4 sending the fax if the fax machine operator indicates override.

6. The method defined in claim 5 sending the fax if the fax machine operator provides a valid PIN.

7. The method defined in claim 1 wherein the receiving the Expected Name further comprises:
receiving the Expected Name from an operator of the calling fax machine entering the Expected Name into the calling fax machine during the faxing operation.

8. The method defined in claim 1 wherein the receiving the Expected Name further comprises:
receiving the Expected Name prior to the faxing operation; and
storing the Expected Name in memory at the calling fax machine for use during the faxing operation.

9. The method defined in claim 1 further comprising:
the remote fax machine authenticating the identity calling fax machine.

10. The method defined in claim 9 wherein the remote fax machine authenticating the identity calling fax machine further comprises:
the remote fax machine receiving a X.509-type Certificate from the calling fax machine via the modem connection, the X.509-type Certificate including a Certificate public key and a Common Name;
the remote fax machine receiving an encrypted nonce from the calling fax machine via the modem connection;
the remote fax machine validating the X.509-type Certificate using a Certificate Authority public key;
the remote fax machine decrypting the nonce with the Certificate public key;
the remote fax machine determining that the decrypted nonce matches the nonce encrypted by the calling fax machine;
the remote fax machine providing an Expected Name associated with the calling fax machine;
the remote fax machine comparing the Common Name with the Expected Name; and
the remote fax machine authenticating the identity of the calling fax machine from the validating and the determining and the comparing.

11. The method defined in claim 9 further comprising:
the calling fax machine sending a fax to the remote fax machine after the calling fax machine authenticating the identity of the remote fax machine and the remote fax machine authenticating the identity of the calling fax machine.

12. The method defined in claim 1 wherein the Expected Name and the Common Name include group level identifiers.

13. The method defined in claim 12 wherein the Expected Name and the Common Name include wildcard characters.

14. The method defined in claim 1 wherein the verifying further comprises:
receiving an encrypted nonce from the remote fax machine;
decrypting the encrypted nonce with a Certificate public key; and
comparing the decrypted nonce with an original nonce.

15. The method defined in claim 1 further comprising exchanging digital signatures with the remote fax machine.

16. The method defined in claim 15 wherein the exchanging digital signatures provides proof that a fax was sent, or provides proof that a fax was received, or provides proof of the time of fax receipt, or verifies the contents of a fax that was sent.

17. A system for authenticating the identity of the remote fax machine during a faxing operation comprising:
a fax machine controller for establishing a modem connection with a remote fax machine, receiving a X.509-type Certificate having a Certificate public key and a Common Name from the remote fax machine via the modem connection, receiving an encrypted nonce from the remote fax machine via the modem connection, validating the X.509-type Certificate, decrypting the nonce with the Certificate public key, comparing the Common Name with an Expected Name, and determining the authenticity of the identity of the remote fax machine.

18. A fax machine comprising:
a controller for establishing a modem connection with a remote fax machine, receiving a X.509-type Certificate having a Certificate public key and a Common Name from the remote fax machine via the modem connection, receiving an encrypted nonce from the remote fax machine via the modem connection, validating the X.509-type Certificate, decrypting the nonce with the Certificate public key, comparing the Common Name with an Expected Name, and determining the authenticity of the identity of the remote fax machine.

19. The fax machine of claim 18 further comprising:
a User Interface receiving the Expected Name input by an operator of the fax machine and providing the Expected Name to the controller.

20. The fax machine of claim 19 further comprising:
a memory connected to the User Interface and controller for storing the Expected Name input by an operator of the fax machine for use by the controller.
